(19) United States
(12) Patent Application Publication
(10) Pub. No.: US 2011/0050682 A1
(43) Pub. Date: Mar. 3, 2011

(54) Liquid Crystal Display Device and Back Light Module of the Liquid Crystal Display Device

(75) Inventors: Kuan-Ming Lin, Hsin-Chu (TW); Mu-Lin Tung, Hsin-Chu (TW); Chao-Ching Hsu, Hsin-Chu (TW)

(73) Assignee: AU OPTRONICS CORPORATION, Hsin-Chu (TW)

(21) Appl. No.: 12/630,123

(22) Filed: Dec. 3, 2009

(30) Foreign Application Priority Data
Aug. 31, 2009 (TW) 98129288

(51) Int. Cl. G09G 3/36; G09G 5/00

(52) U.S. Cl. 345/214; 345/102

(57) ABSTRACT

A back light module of a liquid crystal display device and the liquid crystal display device are provided. The back light module includes a printed circuit board (PCB), a light emitting diode (LED) driver, and a plurality of LED light bars. Each LED light bar has a plurality of LED series. The LED driver simultaneously electrically connects the LED series of different LED light bars via tracks of the PCB.

### RELATED APPLICATIONS

This application claims priority to Taiwan Application Serial Number 98129288, filed Aug. 31, 2009, which is herein incorporated by reference.

### BACKGROUND

1. Technical Field

This disclosure relates to a back light module, and more particularly to a back light module of a liquid crystal display device.

2. Description of Related Art

Due to power-efficient and high luminous efficiency characteristics, light emitting diode (LED) has become a new light tool of this generation, and has been widely used in light sources of display apparatus. However, as a light source of a display apparatus, the brightness of a single LED element is still weaker than that of a traditional fluorescent tube. Because the single LED element is not sufficient as a light source for a display apparatus, multiple LED elements must be used together to provide light to the display apparatus.

Therefore, vendors arrange an LED light bar formed by some LED elements in series on a substrate in which the LED elements of the LED light bar are controlled by a single LED driver.

However, some drawbacks and inconveniences between the LED driver and the controlled LED light bar exist as follows:

1. All LED elements arranged on a single LED light bar causing high manufacturing cost or high substitution cost:

If one of the LED elements on the single LED light bar is damaged, light emitted from the single LED light bar might be dim. An entire single LED light bar might be dumped due to insufficient light. Thus, the failure of a single LED element increases the manufacturing cost or the substitution cost of the LED light bar is dumped or the single LED element is replaced.

2. All LED elements arranged on a single LED light bar causing complicated tracks of input/output circuits:

Since the LED driver is electrically connected with the LED elements, respectively, tracks of input/output circuits between the LED driver and the LED elements will be changed with respect to different arrangements of the LED elements on the LED light bar. Thus, the possibilities of the tracks of the input/output circuits between the LED driver and the LED elements wrongly connected mutually might be raised.

3. Different LED drivers result in different levels of light being emitted from different LED light bars:

Since a current accuracy between two different LED drivers varies within 3%, light levels provided from different LED light bars are different. Therefore, an obvious difference in light levels from the LED light bars is seen by viewers.

4. When the LED driver is out of order, its controlled LED light bar will be out of control, thus, all LED elements of the LED light bar light no more.

Therefore, an issue of how to improve an LED light source to overcome the drawbacks and the inconveniences set forth above should be solved immediately.

### SUMMARY

Therefore, an aspect of the present invention is to present a liquid crystal display device and its back light module. The present invention reduces possibilities of dumping a whole light bar due to one of the LED elements thereon being damaged, so as to further cut down manufacturing cost or substitution cost. The present invention also simplifies the complicated input/output circuits between the LED drivers and the LED elements, so as to further decrease the possibility that the input/output circuits are wrongly connected.

Furthermore, the present invention prevents all LED elements of the LED light bar light being disabled when the controlling LED driver is out of order. Also, the present invention overcomes the issue of different LED drivers with different current levels so as to generate an average light level of different LED light bars, and to make the image on the screen more normal for viewers.

According to an embodiment of the invention, the liquid crystal display device has a back light module. The back light module has a PCB, a plurality of LED light bars, and two LED drivers. The PCB has a plurality of tracks thereon. The LED light bars respectively have a plurality of first LED series and a plurality of second LED series. A first LED driver of the LED drivers is mounted on the PCB and is respectively electrically connected with the first LED series via a portion of the tracks of the PCB. A second LED driver of the LED drivers is mounted on the PCB and is respectively electrically connected with the second LED series via another portion of the tracks of the PCB.

According the other embodiment of the invention, the back light module of the liquid crystal display device includes a PCB, a plurality of LED light bars and a plurality of LED drivers. The PCB has a plurality of tracks thereof. The LED light bars are electrically connected with the tracks of the PCB, and each LED light bar has a plurality of LED series. Each LED series has a plurality of LED elements electrically connected in series, and the LED elements of the LED series are arranged alternately to align in a same linear line on the same LED light bar. The LED drivers are mounted on the PCB, and electrically connected with the tracks of the PCB. Each LED driver has a positive pin and a plurality of negative pin groups, each of the negative pin groups comprising a plurality of negative pins. Also, each LED driver is respectively electrically connected with a part of the LED series of the different LED light bars both through the positive pin thereof and the negative pins of the different negative pin groups.

According to another embodiment of the invention, the back light module of the liquid crystal display device includes a PCB, a plurality of LED light bars, a first LED driver and a second LED driver. The PCB has a plurality of tracks thereof. Each LED light bar has a plurality of first LED series and second LED series. The first LED driver has a first positive pin and a plurality of first negative pins, and is electrically connected with the first LED series of the LED light bars via a first portion of the tracks of the PCB, respectively. The second LED driver has a second positive pin and a plurality of second negative pins, and is electrically connected with the second LED series of the LED light bars via a second portion of the tracks of the PCB, respectively. Also, each of the first LED series comprises a plurality of first LED elements electrically connected in series, and the initial first LED elements of all first LED series are firstly electrically connected with the first positive pin and lastly electrically connected with the first negative pins via the first LED elements other than the initial first LED elements, and the terminal first LED elements of all first LED series are firstly electrically connected with the first negative pins and lastly electrically connected with the first positive pin via the LED elements other than the terminal first LED elements.

Similarly, each second LED series has a plurality of second LED elements electrically connected in series, and the initial second LED elements of all second LED series are firstly electrically connected with the second positive pin and lastly electrically connected with the second negative pins via the second LED elements other than the initial second LED elements, and the terminal second LED elements of all of the second LED series are firstly electrically connected with the second negative pins and lastly electrically connected with the second positive pin via the second LED elements other than the terminal second LED elements.

According to another one embodiment of the invention, the back light module of the liquid crystal display device includes a PCB, three LED light bars, and three LED drivers. The PCB has a plurality of tracks thereof. A first LED driver of the LED drivers is electrically connected with a first portion of the tracks of the PCB, and has a first positive pin, a first negative pin, a second negative pin and a third negative pin. A second LED driver of the LED drivers is electrically connected with a second portion of the tracks of the PCB, and has a second positive pin, a fourth negative pin, a fifth negative pin and a sixth negative pin. A third LED driver of the LED drivers is electrically connected with a third portion of the tracks of the PCB, and has a third positive pin, a seventh negative pin, a eighth negative pin and a ninth negative pin.

A first LED light bar of the LED light bars has a first LED series, a second LED series and a third LED series in which the first LED series is electrically connected with the first negative pin and the first positive pin via the first portion of the tracks of the PCB, the second LED series is electrically connected with the fourth negative pin and the second positive pin via the second portion of the tracks of the PCB, the third LED series is electrically connected with the seventh negative pin and the third positive pin via the third portion of the tracks of the PCB.

A second LED light bar of the LED light bars has a fourth LED series, a fifth LED series and a sixth LED series, in which the fourth LED series is electrically connected with the second negative pin and the first positive pin via the first portion of the tracks of the PCB, the fifth LED series is electrically connected with the fifth negative pin and the second positive pin via the second portion of the tracks of the PCB, the sixth LED series is electrically connected with the eighth negative pin and the third positive pin via the third portion of the tracks of the PCB.

A third LED light bar of the LED light bars has a seventh LED series, an eighth LED series and a ninth LED series in which the seventh LED series is electrically connected with the third negative pin and the first positive pin via the first portion of the tracks of the PCB, the eighth LED series is electrically connected with the sixth negative pin and the second positive pin via the second portion of the tracks of the PCB, the ninth LED series is electrically connected with the ninth negative pin and the third positive pin via the third portion of the tracks of the PCB.

To sum up, the present invention (1) cuts down the manufacturing cost or the substitution cost of the LED light bars, (2) decreases the possibility that the input/output circuits are wrongly connected, (3) keeps the rest of the LED elements of the LED light bar emitting when the single controlling LED driver is out of order, and (4) generates an averaged light level between the different LED light bars to viewers.

### BRIEF DESCRIPTION OF THE DRAWINGS

FIG. 1A is an arrangement schematic diagram of a back light module of a liquid crystal display device according to an embodiment of the invention.

FIG. 1B is a circuit diagram of FIG. 1A.

FIG. 2A is the other arrangement schematic diagram of a back light module of a liquid crystal display device according to other one embodiment of the invention.

FIG. 2B is a circuit diagram of FIG. 2A.

FIG. 3 is another arrangement schematic diagram of a back light module of a liquid crystal display device, and a pin definition diagram of an LED driver according to another embodiment of the invention.

FIG. 4A is an arrangement schematic diagram of a left part of FIG. 3.

FIG. 4B is an arrangement schematic diagram of a middle part of FIG. 3.

FIG. 4C is an arrangement schematic diagram of a right part of FIG. 3.

FIG. 5 is a circuit diagram of a back light module of a liquid crystal display device according to another one embodiment of the invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

A liquid crystal display device and its back light module are provided. The back light module includes a printed circuit board (PCB), a plurality of light emitting diode (LED) light bars, and at least two LED drivers. Each LED light bar has a plurality of LED series on a flexible printed circuit board. Each LED series has a plurality of LED elements arranged and electrically connected in series. The LED drivers are mounted on the PCB, and electrically connect with some tracks of the PCB, respectively. Each LED driver electrically connects with at least one of the LED series of the LED light bars via different tracks on the PCB, so as to control the LED elements of these LED series whether to light or not. Moreover, these LED elements of the different LED series are mutually arranged alternately to align in a same linear line on each flexible printed circuit board (FPC) of the same LED light bar.

Some practiced embodiments will be disclosed as follows in order to clarify technique features of the present invention.

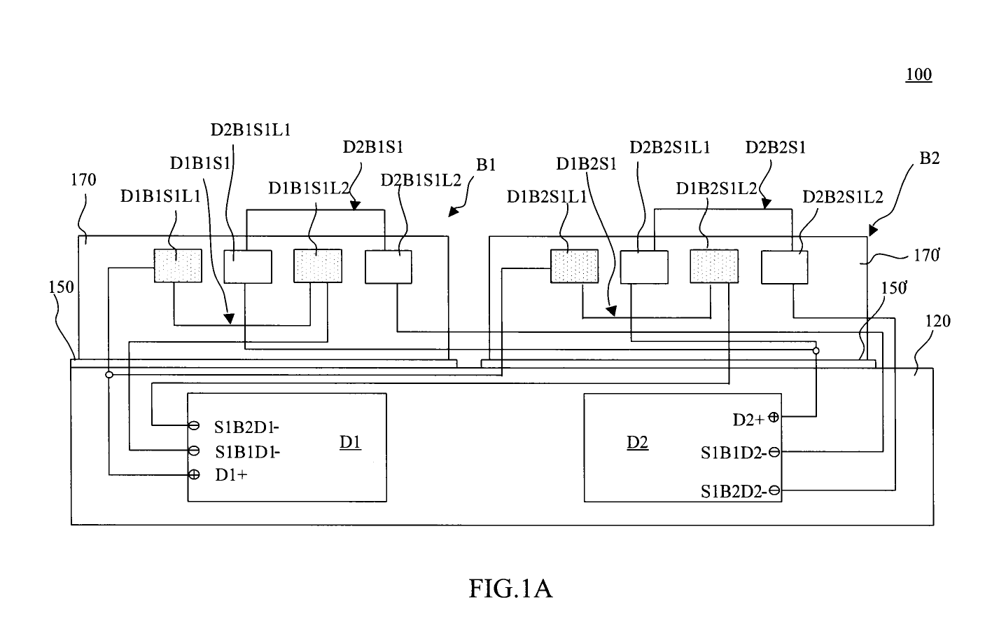

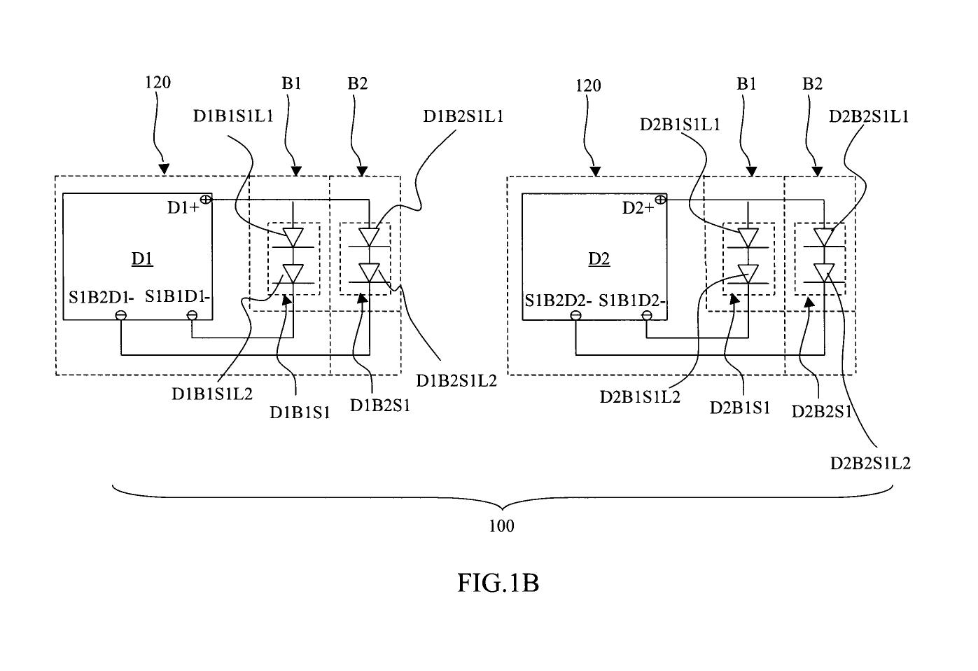

Also, in order to further clearly demonstrate the LED drivers, the LED light bars, the LED series and the LED elements, the specification hereby respectively assigns a reference sign to the LED drivers, the LED light bars, the LED series and the LED elements. Thus, the LED drivers are assigned as “Dp” in which the letter p thereof is variable and is a positive integer for ordinal number, e.g. D1, and the LED light bars are assigned as “Bq” in which the letter q thereof is variable and is a positive integer for ordinal number, e.g. B1, and the LED series are assigned as “DpBqSn”, in which the letters p, q and n thereof are variable and are positive integers for ordinal number, respectively, e.g. D1B1S1, and the LED elements are assigned as “DpBqSnLm”, in which the letters p, q, n and m thereof are variable and are positive integers for ordinal number, respectively, e.g. D1B1S1L1. Refer to FIG. 1A and FIG. 1B. FIG. 1A is an arrangement schematic diagram of a back light module of a liquid crystal display device according to an embodiment of the invention, and FIG. 1B is a circuit diagram of FIG. 1A.

In a back light module 100 of the liquid crystal display device, there are two LED drivers Dp; there are two LED light bars Bq; there are two LED series DpBqSn on each LED light bar; there are two LED series DpBqSn being controlled by each LED driver; and there are two LED elements DpBqSnLm on each LED series.

In detail, the back light module 100 of the liquid crystal display device includes a first LED light bar B1, a second LED light bar B2, a first LED driver D1 and a second LED driver D2. The first LED driver D1 and the second LED driver D2 are respectively mounted on a printed circuit board (PCB) 120, respectively. The first LED driver D1 electrically connects with a portion of tracks of the PCB 120, and the second LED driver D2 electrically connects with another portion of tracks of the PCB 120. The first LED light bar B1 has a flexible printed circuit board (FPC) 170, a first LED series D1B1S1, and a second LED series D2B1S1 both set or arranged on the FPC 170. The second LED light bar B2 has a flexible printed circuit board (FPC) 170′, a first LED series D1B2S1, and a second LED series D2B2S1 both set or arranged on the FPC 170′.

Each LED series is formed by a plurality of LED elements electrically connected in series. For example, a first LED series D1B1S1 is formed by a first LED element D1B1S1L1 and a second LED element D1B1S1L2 electrically connected in series (see dot grid boxes, FIG. 1A), and the second LED series D2B1S1 is formed by a first LED element D2B1S1L1 and a second LED element D2B1S1L2 electrically connected in series (see blank boxes, FIG. 1A), and the first LED series D1B2S1 is formed by a first LED element D1B2S1L1 and a second LED element D1B2S1L2 electrically connected in series (see dot grid boxes, FIG. 1A), and the second LED series D2B2S1 is formed by a first LED element D2B2S1L1 and a second LED element D2B2S1L2 electrically connected in series (see blank boxes, FIG. 1A).

The first LED driver D1 includes a first positive pin D1+ and two first negative pins S1B1D1−, S1B2D1−. The second LED driver D2 includes a second positive pin D2+ and two second negative pins S1B1D2−, S1B2D2−.

The first LED series D1B1S1 of the first LED light bar B1 electrically connects with the first positive pin D1+ and the first negative pin S1B1D1− via corresponding tracks of the PCB 120, a connector 150 and corresponding tracks of input/output circuit of the flexible printed circuit board (FPC) 170, respectively.

Specifically, an initial one LED element (i.e. first LED element D1B1S1L1) of the first LED series D1B1S1 is firstly electrically connected with the first positive pin D1+ of the first LED driver D1 and lastly electrically connected with one of the first negative pins (i.e. first negative pin S1B1D1−), and a terminal one LED element (i.e. second LED element D1B1S1L2) of the first LED series D1B1S1 is firstly electrically connected with the first negative pins S1B1D1− of the first LED driver D1 and lastly electrically connected with the first positive pin D1+.

The first LED series D1B2S1 of the second LED light bar B2 electrically connects with the first positive pin D1+ and the first negative pins S1B2D1− via tracks of the PCB 120, a connector 150′ and tracks of input/output circuit of the flexible printed circuit board (FPC) 170′, respectively.

Specifically, an initial one LED element (i.e. first LED element D1B2S1L1) of the first LED series D1B2S1 is firstly electrically connected with the first positive pin D1+ of the first LED driver D1 and lastly electrically connected with one of the first negative pins (i.e. first negative pin S1B2D1−), and a terminal one LED element (i.e. second LED element D1B2S1L2) of the first LED series D1B2S1 is firstly electrically connected with the first negative pins S1B2D1− of the first LED driver D1, and lastly electrically connected with the first positive pin D1+ via the via the first LED elements other than the terminal one LED element.

Similarly, refer to the second LED driver D2 in FIG. 1B. The second LED driver D2 also electrically connects with the second LED series D2B1S1 of the first LED light bar B1, and the second LED series D2B2S1 of the second LED light bar B2.

Specifically, an initial one LED element (i.e. first LED element D2B1S1L1) of the second LED series D2B1S1 is firstly electrically connected with the second positive pin D2+ of the second LED driver D2 and lastly electrically connected with one of the second negative pins (i.e. second negative pin S1B1D2−), and a terminal one LED element (i.e. second LED element D2B1S1L2) of the second LED series D2B1S1 is firstly electrically connected with the second negative pins S1B1D2− of the second LED driver D2 and lastly electrically connected with the second positive pin D2+.

Similarly, an initial one LED element (i.e. first LED element D2B2S1L1) of the second LED series D2B2S1 is firstly electrically connected with the second positive pin D2+ of the second LED driver D2 and lastly electrically connected with one of the second negative pins (i.e. second negative pin S1B1D2−), and a terminal one LED element (i.e. second LED element D2B2S1L2) of the second LED series D2B2S1 is firstly electrically connected with the second negative pins S1B2D2− of the second LED driver D2 and lastly electrically connected with the second positive pin D2+.

Thus, when one of the LED light bars malfunctions, since the rest of the LED light bars are still working, and the LED light bars do not need to be changed entirely. Thus, the manufacturing cost or the substitution cost of the LED light bars can be further lowered. Also, the more quantity of the LED light bars is provided, the simplifier input/output circuit tracks between the LED drivers and the LED elements can be achieved. Thus, the possibility of the input/output circuit tracks between the LED driver and the LED elements wrongly connected might be lowered.

Furthermore, each of the LED drivers controls different LED series arranged on different LED light bars. Thus, when one of the LED drivers malfunctions and the corresponding LED series is therefore out of order, the rest of the LED series on the single LED light bar still work to cover the darkness that the disabled LED series presents. Accordingly, if more LED drivers are used, more LED elements of the LED series can provide lightness on the single LED light bar.

Additionally, refer to FIG. 1A. The first LED series D1B1S1 and the second LED series D2B1S1 are aligned on the same linear line on a flexible printed circuit board or a printed circuit board of the first light bar B1. Also, the two LED elements D1B1S1L1, D1B1S1L2 of the first LED series D1B1S1 and the two LED elements D2B1S1L1, D2B1S1L2 of the second LED series D2B1S1 are arranged alternately. Specifically, the two LED elements D1B1S1L1, D1B1S1L2 of the first LED series D1B1S1 and the two LED elements D2B1S1L1, D2B1S1L2 of the second LED series D2B1S1 are arranged in accordance with a following order as the first LED element D1B1S1L1, the first LED element D2B1S1L2, the second LED element D1B1S1L2, and the second LED element D2B1S1L2.

Similarly, the first LED series D1B2S1 and the second LED series D2B2S1 are arranged to align in a same linear line on a flexible printed circuit board or a printed circuit board of the second light bar B2. The two LED elements D1B2S1L1, D1B2S1L2 of the first LED series D1B2S1 and the two LED elements D2B2S1L1, D2B2S1L2 of the second LED series D2B2S1 are arranged alternately. Specifically, the two LED elements D1B2S1L1, D1B2S1L2 of the first LED series D1B2S1 and the two LED elements D2B2S1L1, D2B2S1L2 of the second LED series D2B2S1 are arranged in the following order as the first LED element D1B2S1L1, the first LED element D2B2S1L1, the second LED element D1B2S1L2, and the second LED element D2B2S1L2.

Therefore, by mixing the LED elements of different LED light bars to average the light levels from the different LED light bars, and generate an averaged light level, viewers are satisfied.

Note that all the LED elements mentioned above in FIG. 1A and FIG. 1B are preferably the same in format and size. These LED elements will not be different because of the different appearance of the blank or dot grid boxes in FIG. 1A.

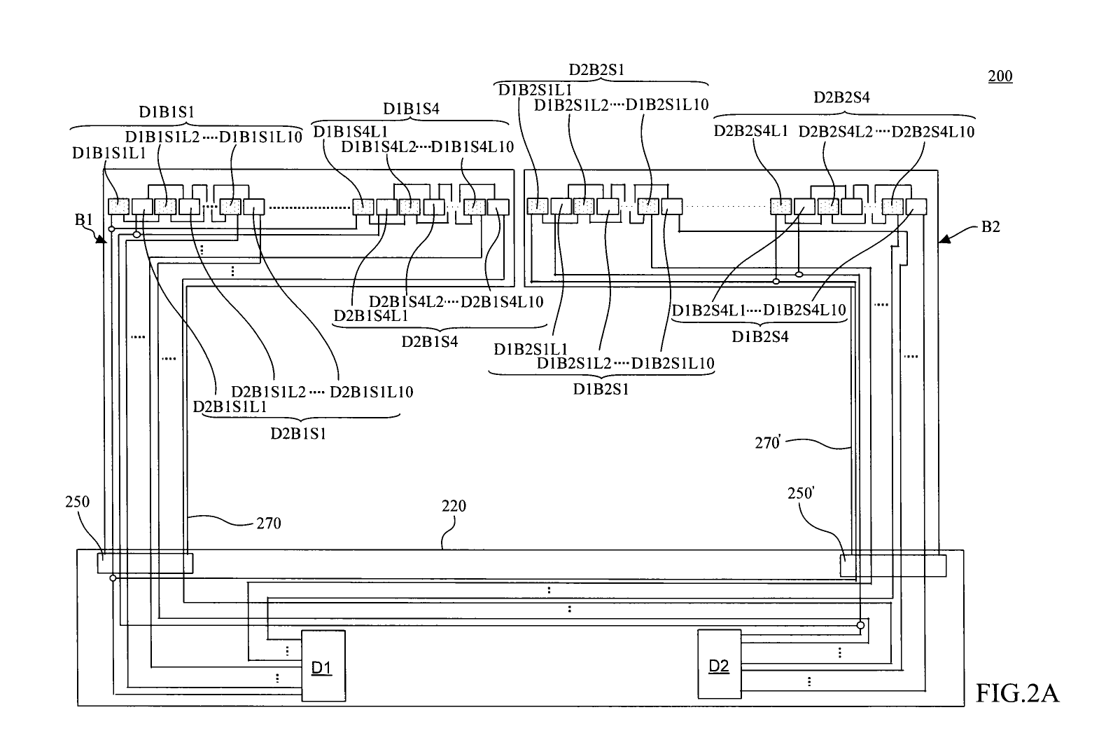

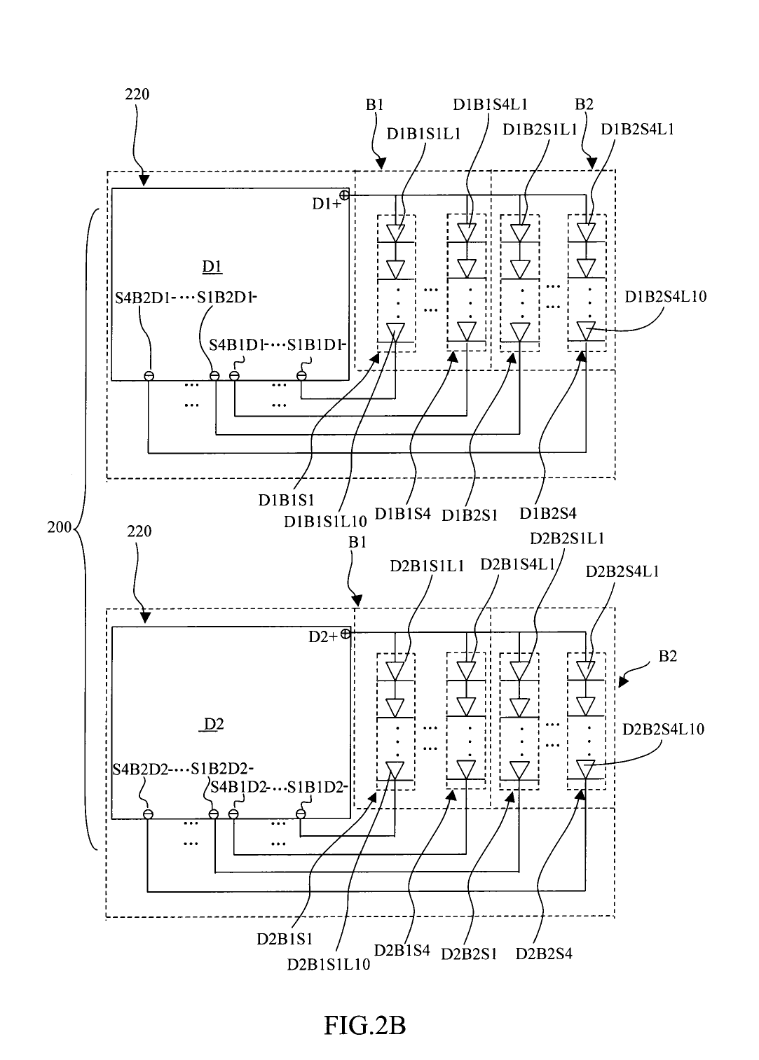

Refer to FIG. 2A and FIG. 2B. FIG. 2A is the other arrangement schematic diagram of a back light module of a liquid crystal display device according to the other embodiment of the invention. FIG. 2B is a circuit diagram of FIG. 2A.

In a back light module 200 of the liquid crystal display device, the number of the LED light bars Bq and the number of the LED drivers Dp are the same, and the number of the LED light bars Bq is an even number. For example, in this embodiment, there are two LED drivers Dp, and there are two LED light bars Bq.

The numbers of the LED series DpBqSn disposed on the same LED light bar Bq and electrically connected with the different LED drivers Dp respectively are the same with each other. For example, in this embodiment, the eight LED series DpBqSn are controlled by each LED driver Dp.

The numbers of the LED elements DpBqSnLm for each LED series DpBqSn are the same with each other. For example, in this embodiment, there are ten LED elements DpBqSnLm arranged for each single LED series DpBqSn.

In detail, the back light module 200 of the liquid crystal display device includes a first LED light bar B1, a second LED light bar B2, a first LED driver D1 and a second LED driver D2. The first LED driver D1 and the second LED driver D2 are respectively mounted on a printed circuit board (PCB) 220, and electrically connect with the PCB 220, respectively. (See FIG. 2A) The first LED light bar B1 has a flexible printed circuit board (FPC) 270, and the second LED light bar B2 has a flexible printed circuit board (FPC) 270′.

Refer to FIG. 2B. The first LED driver D1 controls four LED series D1B1S1-D1B1S4 on the FPC 270 of the first LED light bar B1, and another four LED series D1B2S1-D1B2S4 on the FPC 270′ of the second LED light bar B2. The second LED driver D2 controls four LED series D2B1S1-D2B1S4, and another four LED series D1B2S1-D1B2S4 on the second LED light bar B2. Each of the LED series DpBqSn is formed by a plurality of the LED elements DpBqSnLm electrically connected in series. For example, the first LED series D1B1S1 is formed by ten LED elements (i.e. D1B1S1L1-D1B1S1L10 as presented as the dot grid boxes in FIG. 2A).

The first LED driver D1 includes a first positive pin D1+ and a plurality of negative pin groups. Each of negative pin groups has a plurality of first negative pins. The first negative pins of different negative pin groups electrically connect with different LED light bars Bq, for example, four negative pins S1B1D1− to S4B1D1− in a negative pin group electrically connect with a part of the LED series of the first LED light bar B1, and another four negative pins S1B2D1− to S4B2D1− in another negative pin group electrically connect with another part of the LED series of the second LED light bar B2.

The second LED driver D2 includes a second positive pin D2+ and a plurality of negative pin groups. Each negative pin group has a plurality of second negative pins. The second negative pins of different negative pin groups respectively electrically connect with different LED light bars Bq, for example, four negative pins S1B1D2− to S4B1D2− in a negative pin group electrically connect with a part of the LED series of the first LED light bar B1, and another four negative pins S1B2D2− to S4B2D2− in another negative pin group electrically connect with another part of the LED series of the second LED light bar B2.

Refer to FIG. 2A and FIG. 2B. The first LED driver D1 electrically connects the LED series D1B1S1˜D1B1S4 of the first LED light bar B1 using the corresponding first negative pins S1B1D1− to S4B1D1− and the first positive pin D1+ respectively via the PCB 220, a connector 250 and tracks of input/output circuit of the flexible printed circuit board (FPC) 270.

Also, the first LED driver D1 electrically connects the LED series D1B2S1˜D1B2S4 the LED light bar B2 using the corresponding first negative pins S1B2D1− to S4B2D1− and the first positive pin D1+ respectively via the PCB 220, a connector 250′ and tracks of input/output circuit of the flexible printed circuit board (FPC) 270′.

The second LED driver D2 electrically connects the LED series D2B1S1˜D2B1S4 of the first LED light bar B1 using the corresponding second negative pins S1B1D2− to S4B1D2− and the second positive pin D2+ respectively via the PCB 220, the connector 250 and tracks of the input/output circuit of the flexible printed circuit board 270.

Also, the second LED driver D2 electrically connects the LED series D2B2S1˜D2B2S4 the LED light bar B2 using the corresponding second negative pins S1B2D2− to S4B2D2− and the second positive pin D2+ respectively via the PCB 220, the connector 250′ and tracks of the input/output circuit of the flexible printed circuit board 270′.

Specifically, in the mentioned LED series DpBqSn, each initial LED element DpBqSnL1 thereof firstly electrically connects with a positive pin Dp+ of the corresponding LED driver Dp and lastly electrically connects with the different negative pins SnBqDp− of the corresponding LED driver Dp, respectively, and each terminal LED element DpBqSnLm thereof firstly electrically connects with the different negative pins SnBqDp− of the corresponding LED driver DP and lastly electrically connects with the positive pin Dp+.

For example, an initial LED element D1B1S1L1 of the LED series D1B1S1 firstly electrically connects with a first positive pin D1+ of the first LED driver D1 and lastly electrically connects with the first negative pin S1B1D1−, and a terminal LED element D1B1S1L10 of the LED series D1B1S1 firstly electrically connects with a first negative pin S1B1D1− of the first LED driver D1, and lastly electrically connects with the first positive pin D1+.

For another example, an initial LED element D2B1S1L1 of the LED series D2B1S1 firstly electrically connects with a second positive pin D2+ of the second LED driver D2 and lastly electrically connects with the second negative pin S1B1D2−, and a terminal LED element D2B1S1L10 of the LED series D2B1S1 electrically connects with a second negative pin S1B1D2− of the second LED driver D2, and lastly electrically connected with the second positive pin D2+.

Therefore, by analogy with the examples mentioned above, the reader can deduce how the remaining LED series are electrically connected with the corresponding negative pins and positive pins.

Refer to FIG. 2A. In this embodiment, all LED elements of the LED series D1B1S1˜D1B1S4 and the LED series D2B1S1˜D2B1S4 are arranged alternately to align on the same linear line on the first light bar B1. Particularly, the LED elements of the LED series D1B1S1˜D1B1S4 and the LED series D2B1S1˜D2B1S4 are arranged in accordance with a following order as LED element D1B1S1L1, LED element D2B1S1L1, LED element D1B1S1L2, LED elements D2B1S1L2, LED element D1B1S1L3, LED elements D2B1S1L3, . . . , LED element D1B1S1L10, LED element D2B1S1L10, LED element D1B1S2L1, LED element D2B1S2L1, LED element D1B1S2L2, LED element D2B1S2L2, LED element D1B1S2L3, LED element D2B1S2L3, . . . , LED element D1B1S2L10, LED element D2B1S2L10, . . . , LED element D1B1S4L1, LED element D2B1S4L1, LED element D1B1S4L2, LED element D2B1S4L2, . . . , LED element D1B1S4L10, and LED element D2B1S4L10.

Similarly, all LED elements of the LED series D1B2S1˜D1B2S4 and the LED series D2B2S1˜D2B2S4 are arranged alternately to align on the same linear line on the second light bar B2. Particularly, the LED elements of the LED series D1B2S1˜D1B2S4 and the LED series D2B2S1˜D2B2S4 are arranged in accordance with a following order as LED element D1B2S1L1, LED element D2B2S1L1, LED element D1B2S1L2, LED elements D2B2S1L2, LED element D1B2S1L3, LED elements D2B2S1L3, . . . , LED element D1B2S1L10, LED element D2B2S1L10, LED element D1B2S2L1, LED element D2B2S2L1, LED element D1B2S2L2, LED element D2B2S2L2, LED element D1B2S2L3, LED element D2B2S2L3, . . . , LED element D1B2S2L10, LED element D2B2S2L10, . . . , LED element D1B2S4L1, LED element D2B2S4L1, LED element D1B2S4L2, LED element D2B2S4L2, . . . , LED element D1B2S4L10, and LED element D2B2S4L10.

As deduced above, the numbers of the negative pins of each LED driver Dp for respectively electrically connecting with different LED light bars Bq are the same with each other.

Note that all of the LED elements mentioned above in FIG. 2A and FIG. 2B are preferably the same in format and size. These LED elements will not be different because of the different appearance of the blank or dot grid boxes in FIG. 2A.

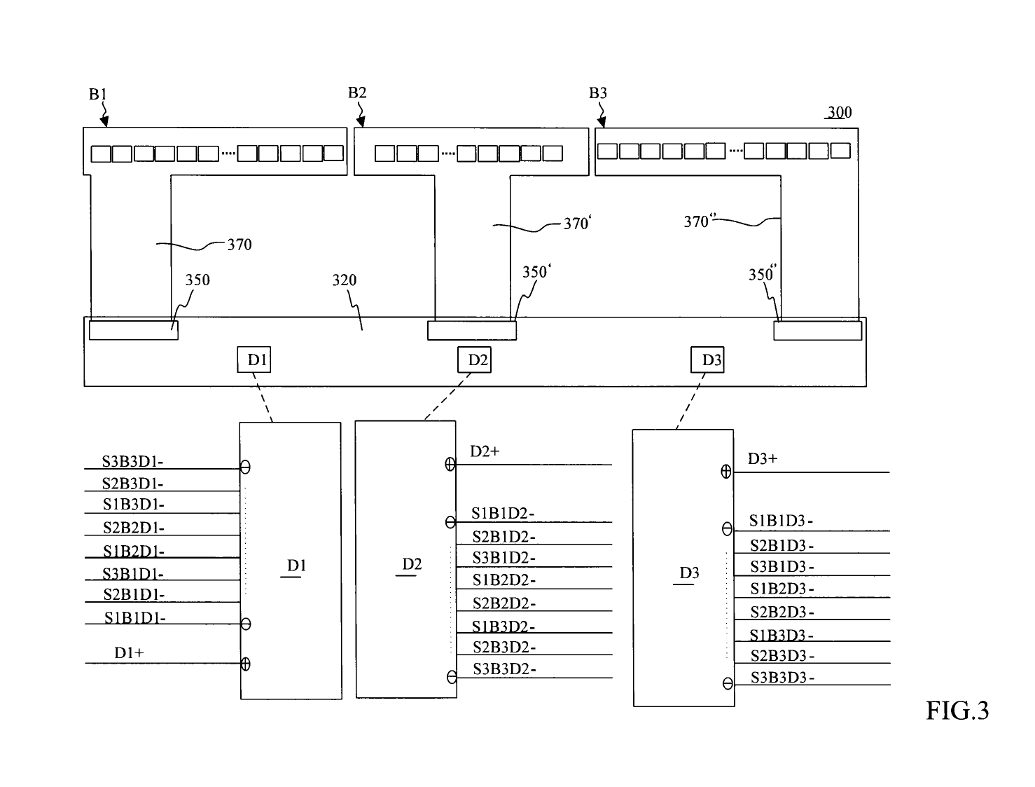

Refer to FIG. 3. FIG. 3 is another arrangement schematic diagram of a back light module of a liquid crystal display device, and a pin definition diagram of an LED driver according to another embodiment of the invention.

In a back light module 300 of the liquid crystal display device, the number of the LED light bars Bq and the number of the LED drivers Dp are the same, and the number of the LED light bars Bq is an odd number but is greater than one (e.g. 3, 5 or 7). For example, in this embodiment, there are three LED drivers Dp, and three LED light bars Bq.

The numbers of the LED series DpBqSn which are electrically connected with the same LED driver Dp and disposed on different LED light bar Bq are different with each other. For example, in this embodiment, two or three LED series DpBqSn are electrically connected with and controlled by each LED driver Dp. The number of LED elements DpBqSnLm for each LED series DpBqSn is not the same with each other. For example, in this embodiment, there are six or seven LED elements DpBqSnLm for each single LED series DpBqSn.

In detail, the back light module 300 of the liquid crystal display device includes a first LED light bar B1, a second LED light bar B2, a third LED light bar B3, a first LED driver D1, a second LED driver D2 and a third LED driver D3. The first LED driver D1, the second LED driver D2 and the third LED driver D3 are respectively mounted on a printed circuit board (PCB) 320, and electrically connect with the PCB 320, respectively. (See FIG. 3)

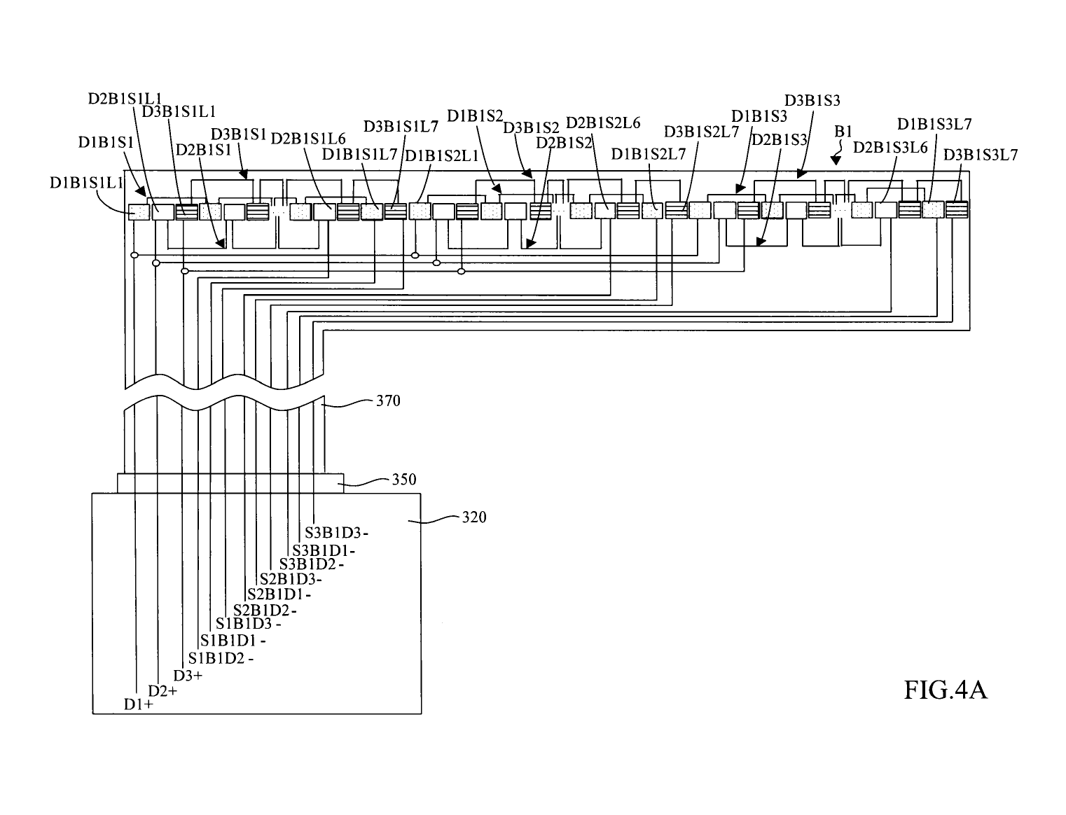

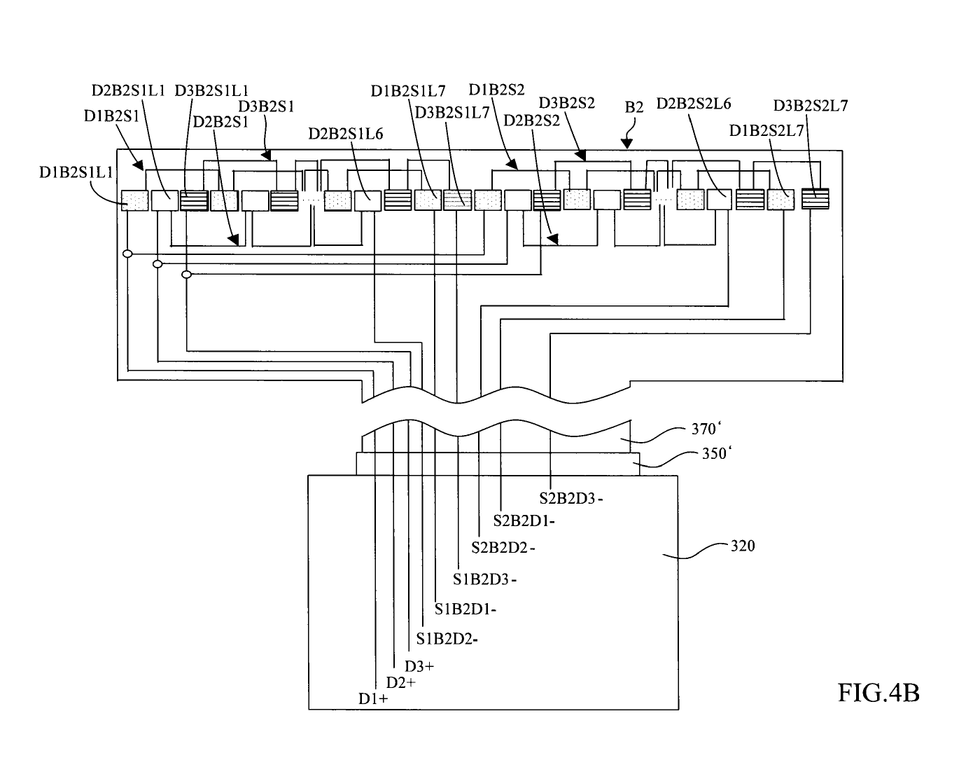

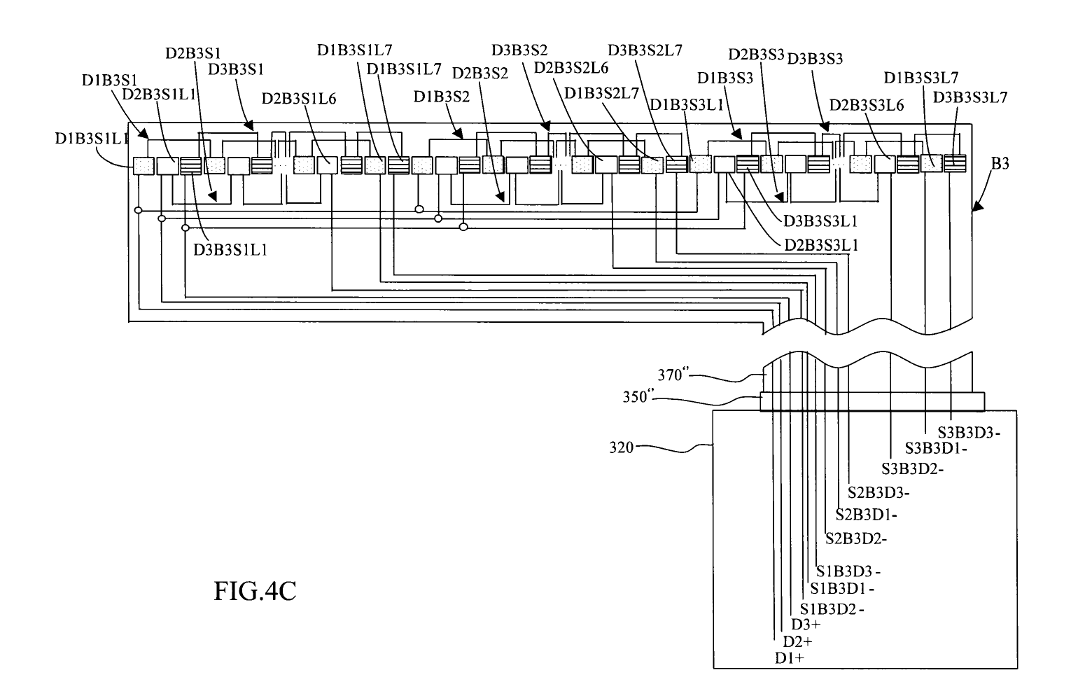

Refer to FIG. 4A, FIG. 4B and FIG. 4C. FIG. 4A, FIG. 4B and FIG. 4C are respectively arrangement schematic diagrams of a left part, a middle part and a right part of FIG. 3. When referring to FIG. 4A, FIG. 4B or FIG. 4C, FIG. 3 also can be an aid for reference.

The first LED driver D1 respectively controls three of first LED series (e.g. LED series D1B1S1˜D1B1S3) of the first LED light bar B1, two of fourth LED series (e.g. LED series D1B2S1˜D1B2S2) of the second LED light bar B2, and three of seventh LED series (e.g. LED series D1B3S1˜D1B3S3) of the third LED light bar B3 as one to many. The first LED light bar B1 has a flexible printed circuit board (FPC) 370, the second LED light bar B2 has a flexible printed circuit board (FPC) 370′, and the third LED light bar B3 has a flexible printed circuit board (FPC) 370″.

The second LED driver D2 respectively controls three of second LED series (e.g. LED series D2B1S1˜D2B1S3) on the FPC 370 of the first LED light bar B1, two of fifth LED series (e.g. LED series D2B2S1˜D2B2S2) on the FPC 370′ of the second LED light bar B2, and three of eighth LED series (e.g. LED series D2B3S1˜D2B3S3) on the FPC 370″ of the third LED light bar B3 as one to many.

The third LED driver D3 respectively controls three of third LED series (e.g. LED series D3B1S1˜D3B1S3) of the first LED light bar B1, two of sixth LED series (e.g. LED series D3B2S1˜D3B2S2) of the second LED light bar B2, and three of ninth LED series (e.g. LED series D3B3S1˜D3B3S3) of the third LED light bar B3 as one to many.

The references “m” referred to the number of the LED elements DpBqSnLm of each LED series DpBqSnLm is not the same with each other. The first LED series, for instance, an LED series D1B1S1 is made of 7 LED elements (i.e. D1B1S1L1˜D1B1S1L7 as presented as the dot grid boxes in FIG. 4A). The second LED series, for instance, an LED series D2B1S1 is made of six LED elements (i.e. D2B1S1L1˜D2B1S1L6 as presented as the blank boxes in FIG. 4A). The third LED series, for instance, an LED series D3B1S1 is made up of seven LED elements (i.e. D3B1S1L1˜D3B1S1L7 as presented as the horizontal line boxes in FIG. 4A).

The first LED driver D1 includes a first positive pin D1+ and three of negative pin groups. One of the three negative pin groups has a plurality of first negative pins (e.g. three negative pins S1B1D1− to S3B1D1−). The other one of the three negative pin groups has a plurality of second negative pins (e.g. two negative pins S1B2D1− to S2B2D1−). The last one of the three negative pin groups has a plurality of third negative pins (e.g. three negative pins S1B3D1− to S3B3D1−).

The first negative pins, the second negative pins, and the third negative pins are respectively electrically connected with different LED light bars Bq. For example, the first negative pins S1B1D1− to S3B1D1− electrically connect with the first LED light bar B1, the second negative pins S1B2D1− to S2B2D1− electrically connect with the second LED light bar B2, and the third negative pins S1B3D1− to S3B3D1− electrically connect with the third LED light bar B3.

The second LED driver D2 includes a second positive pin D2+ and three of negative pin groups. One of the three negative pin groups has a plurality of fourth negative pins (e.g. three negative pins S1B1D2− to S3B1D2−). The other one of the three negative pin groups has a plurality of fifth negative pins (e.g. two negative pins S1B2D2− to S2B2D2−). The last one of the three negative pin groups has a plurality of sixth negative pins (e.g. three negative pins S1B3D2− to S3B3D2−).

The fourth negative pins, the fifth negative pins, and the sixth negative pins respectively electrically connect with different LED light bars Bq. For example, the fourth negative pins S1B1D2− to S3B1D2− electrically connect with the first LED light bar B1, the fifth negative pins S1B2D2− to S2B2D2− electrically connect with the second LED light bar B2, and the sixth negative pins S1B3D2− to S3B3D2− electrically connect with the third LED light bar B3.

The third LED driver D3 includes a third positive pin D3+ and three of negative pin groups. One of the three negative pin groups has a plurality of seventh negative pins (e.g. three negative pins S1B1D3− to S3B1D3−). The other one of the three negative pin groups has a plurality of eighth negative pins (e.g. two negative pins S1B2D3− to S2B2D3−). The last one of the three negative pin groups has a plurality of ninth negative pins (e.g. three negative pins S1B3D3− to S3B3D3−).

The seventh negative pins, the eighth negative pins, and the ninth negative pins respectively electrically connect with different LED light bars Bq. For example, the seventh negative pins S1B1D3− to S3B1D3− electrically connect with the first LED light bar B1, the eighth negative pins S1B2D3− to S2B2D3− electrically connect with the second LED light bar B2, and the ninth negative pins S1B3D3− to S3B3D3− electrically connect with the third LED light bar B3.

As deduced above, in this embodiment, the number of the negative pins of some negative pin groups of the LED driver Dp can be different to that of another negative pin group thereof. Thus, it also means the numbers of the negative pins of each LED driver Dp for respectively electrically connecting with different LED light bars Bq are different.

Referring to FIG. 4A, FIG. 4B or FIG. 4C, FIG. 3 can be an aid for reference. The first LED series (e.g. LED series D1B1S1) of the first LED light bar B1 electrically connects with the first negative pin (e.g. negative pin S1B1D1−) and the first positive pin D1+ respectively via tracks of input/output circuit of the flexible printed circuit board 370, a connector 350 and the PCB 320.

The second LED series (e.g. LED series D2B1S1) of the first LED light bar B1 electrically connects with the fourth negative pin (e.g. negative pin S1B1D2−) and the second positive pin D2+ respectively via tracks of the input/output circuit of the flexible printed circuit board 370, the connector 350 and the PCB 320.

The third LED series (e.g. LED series D3B1S2) of the first LED light bar B1 electrically connects with the seventh negative pin (e.g. negative pin S1B1D3−) and the third positive pin D3+ respectively via tracks of the input/output circuit of the flexible printed circuit board 370, the connector 350 and the PCB 320.

The fourth LED series (e.g. LED series D1B2S1) of the second LED light bar B2 electrically connects with the second negative pin (e.g. negative pin S1B2D1−) and the first positive pin D1+ respectively via tracks of input/output circuit of the flexible printed circuit board 370′, a connector 350′ and the PCB 320.

The fifth LED series (e.g. LED series D2B2S1) of the second LED light bar B2 electrically connects with the fifth negative pin (e.g. negative pin S1B2D2−) and the second positive pin D2+ respectively via tracks of the input/output circuit of the flexible printed circuit board 370′, the connector 350′ and the PCB 320.

The sixth LED series (e.g. LED series D3B2S1) of the second LED light bar B2 electrically connects with the eighth negative pin (e.g. negative pin S1B2D3−) and the third positive pin D3+ respectively via tracks of the input/output circuit of the flexible printed circuit board 370′, the connector 350′ and the PCB 320.

The seventh LED series (e.g. LED series D1B3S1) of the third LED light bar B3 electrically connects with the third negative pin (e.g. negative pin S1B3D1−) and the first positive pin D1+ respectively via tracks of input/output circuit of the flexible printed circuit board 370″, a connector 350″ and the PCB 320.

The eighth LED series (e.g. LED series D2B3S1) of the third LED light bar B3 electrically connects with the sixth negative pin (e.g. negative pin S1B3D2−) and the second positive pin D2+ respectively via tracks of the input/output circuit of the flexible printed circuit board 370″, the connector 350″ and the PCB 320.

The ninth LED series (e.g. LED series D3B3S1) of the third LED light bar B3 electrically connects with the ninth negative pin (e.g. negative pin S1B3D3−) and the third positive pin D3+ respectively via tracks of the input/output circuit of the flexible printed circuit board 370″, the connector 350″ and the PCB 320.

Refer to FIG. 4A. In this embodiment, all LED elements of the different LED series D1B1S1˜D1B1S3, the LED series D2B1S1˜D2B1S3, and the LED series D3B1S1˜D3B1S3 are arranged alternately to align in a same linear line on the first light bar B1. Particularly, the LED elements of the LED series D1B1S1˜D1B1S3, the LED series D2B1S1˜D2B1S3, and the LED series D3B1S1˜D3B1S3 are arranged in accordance with a following order as LED element D1B1S1L1, LED element D2B1S1L1, LED element D3B1S1L1, LED element D1B1S1L2, LED element D2B1S1L2, LED element D3B1S1L2, . . . , LED element D1B1S1L6, LED element D2B1S1L6, LED element D3B1S1L6, LED element D1B1S1L7, LED element D3B1S1L7, LED element D1B1S2L1, LED element D2B1S2L1, LED element D3B1S2L1, LED element D1B1S2L2, LED element D2B1S2L2, LED element D3B1S2L2, . . . , LED element D1B1S2L6, LED element D2B1S2L6, LED element D3B1S2L6, LED element D1B1S2L7, LED element D3B1S2L7, LED element D1B1S3L1, LED element D2B1S3L1, LED element D3B1S3L1, LED element D1B1S3L2, LED element D2B1S3L2, LED element D3B1S3L2, . . . , LED element D1B1S3L6, LED element D2B1S3L6, LED element D3B1S3L6, LED element D1B1S3L7, and LED element D3B1S3L7.

Refer to FIG. 4B. In this embodiment, all LED elements of the different LED series D1B2S1˜D1B2S2, the LED series D2B2S1˜D2B2S2, and the LED series D3B2S1˜D3B2S2 are arranged alternately to align in a same linear line on the first light bar B2. Particularly, the LED elements of the LED series D1B2S1˜D1B2S2, the LED series D2B2S1˜D2B2S2, and the LED series D3B2S1˜D3B2S2 are arranged in accordance with a following order as LED element D1B2S1L1, LED element D2B2S1L1, LED element D3B2S1L1, LED element D1B2S1L2, LED element D2B2S1L2, LED element D3B2S1L2, . . . , LED element D1B2S1L6, LED element D2B2S1L6, LED element D3B2S1L6, LED element D1B2S1L7, LED element D3B2S1L7, LED element D1B2S2L1, LED element D2B2S2L1, LED element D3B2S2L1, LED element D1B2S2L2, LED element D2B2S2L2, LED element D3B2S2L2, . . . , LED element D1B2S2L6, LED element D2B2S2L6, LED element D3B2S2L6, LED element D1B2S2L7, and LED element D3B2S2L7.

Refer to FIG. 4C. In this embodiment, all LED elements of the LED series D1B3S1˜D1B3S3, the LED series D2B3S1˜-D2B3S3, and the different LED series D3B3S1˜D3B3S3 are arranged alternately to align in a same linear line on the first light bar B3. Particularly, the LED elements of the LED series D1B3S1˜D1B3S3, the LED series D2B3S1˜D2B3S3, and the LED series D3B3S1˜D3B3S3 are arranged in accordance with a following order as LED element D1B3S1L1, LED element D2B3S1L1, LED element D3B3S1L1, LED element D1B3S1L2, LED element D2B3S1L2, LED element D3B3S1L2, . . . , LED element D1B3S1L6, LED element D2B3S1L6, LED element D3B3S1L6, LED element D1B3S1L7, LED element D3B3S1L7, LED element D1B3S2L1, LED element D2B3S2L1, LED element D3B3S2L1, LED element D1B3S2L2, LED element D2B3S2L2, LED element D3B3S2L2, . . . , LED element D1B3S2L6, LED element D2B3S2L6, LED element D3B3S2L6, LED element D1B3S2L7, LED element D3B3S2L7, LED element D1B3S3L1, LED element D2B3S3L1, LED element D3B3S3L1, LED element D1B3S3L2, LED element D2B3S3L2, LED element D3B3S3L2, . . . , D1B3S3L6, LED element, LED element D2B3S3L6, LED element D3B3S3L6, LED element D1B3S3L7, and LED element D3B3S3L7.

Note that all the LED elements mentioned above in FIG. 4A, FIG. 4B and FIG. 4C are preferably the same in format and size. These LED elements will not be different because of the different appearance of the blank, dot grid or horizontal line boxes in FIG. 4A, FIG. 4B and FIG. 4C.

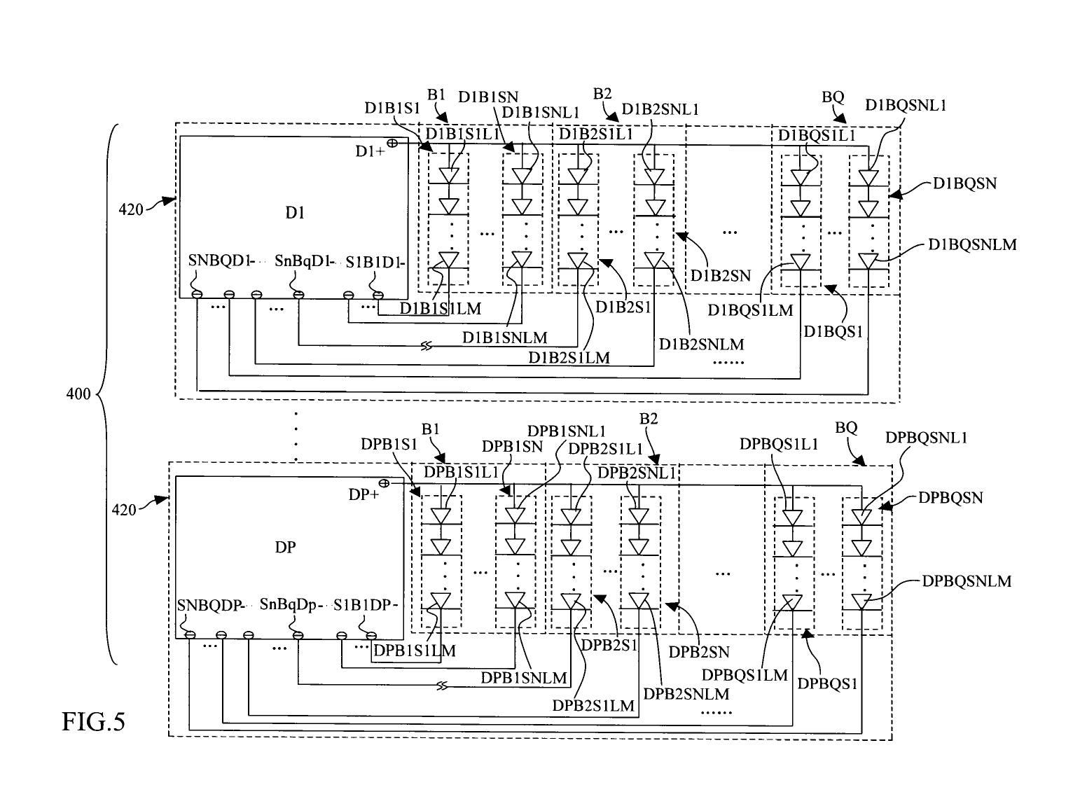

FIG. 5 is a circuit diagram of a back light module of a liquid crystal display device according to another one embodiment of the invention. According to the embodiments mentioned above illustrating the odd number of the LED light bars and the LED drivers but greater than one, and the even number of the LED light bars and the LED drivers, a back light module 400 of the liquid crystal display device with much more LED light bars and LED drivers can be deduced easily.

For example, the number of the LED drivers is assigned as “P”, in which the letter “P” is variable and is a positive integer, e.g. LED drivers Dp (D1˜DP), the letter “P” can be 10, 20 or more. The number of the LED light bars is assigned as “Q”, in which the letter “Q” is variable and is a positive integer, e.g. LED light bars Bq (B1˜BQ), the letter “Q” can be 10, 20 or more. The number of the LED series arranged on each LED light bar BQ and electrically connected with one of the LED drivers is assigned as “N”, in which the letter “N” is variable and is a positive integer, e.g. the LED series DpBqSn (D1B1S1˜DPBQSN), the letter “N” can be 10, 20 or more. The number of the LED elements for one LED series is assigned as “M”, in which the letter “M” is variable and is a positive integer, e.g. the LED elements DpBqSnLm (D1B1S1L1˜DPBQSNLM), the letter “M” can be 10, 20 or more.

In the back light module 400 of the liquid crystal display device, the LED drivers Dp (D1˜DP), which are “P” in number, are mounted on a printed circuit board (PCB) 420 and electrically connected with the PCB 420. The LED drivers Dn (D1˜DP) respectively control the LED light bars Bq (B1˜BQ), which are “Q” in number, to electrically connect with the LED series D1B1Sn (D1B1S1˜D1B1SN), which are “N” in number, arranged on each of the LED light bar Bq (B1˜BQ). Each of the LED series D1B1Sn (D1B1S1˜D1B1SN) has LED elements which are “M” in number. Same here, each LED driver Dp (D1˜DP) has a positive pin Dp+(D1+˜DP+) and several negative pins SnBqDp− (S1B1D1−˜SNBQDP−) respectively.

Therefore, once the LED drivers and the LED light bars increase, the number of LED elements respectively controlled by each LED driver on different light bars will get smaller. Thus, when one of the LED drivers malfunctions, the number of corresponding LED elements going out of order will decrease, and will not influence seriously effectiveness of light produced from the entire LED light bar.

Also, since different LED series are arranged alternately to align in a same linear line on the light bar, light levels of different LED light bars are then averaged, thus, it lowers the possibility of degrading light quality for users.

To sum up, the present invention (1) cuts down manufacturing cost or substitution cost of the LED light bar, (2) decrease the possibility that the input/output circuits are wrongly connected, (3) provides the rest of the LED elements of the LED light bar to light when the single controlling LED driver is out of order, and (4) averages light levels of different LED light bars to further satisfy users.

The reader's attention is directed to all papers and documents which are filed concurrently with his specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A back light module of a liquid crystal display device, comprising:
a printed circuit board (PCB) having a plurality of tracks thereof;
a plurality of light emitting diode (LED) light bars, each of the LED light bars comprising a plurality of first LED series and a plurality of second LED series;
a first LED driver mounted on the PCB, respectively electrically connected with the first LED series via a portion of the tracks of the PCB; and
a second LED driver mounted on the PCB, respectively electrically connected with the second LED series via another portion of the tracks of the PCB.

2. The back light module of the liquid crystal display device as claimed in claim 1, wherein the first LED driver has a first positive pin and a plurality of first negative pins thereof.

3. The back light module of the liquid crystal display device as claimed in claim 2, wherein each of the first LED series comprises a plurality of first LED elements electrically connected in series, wherein an initial one of the first LED elements is firstly electrically connected with the first positive pin and lastly electrically connected with one of the first negative pins, and a terminal one of the first LED elements is firstly electrically connected with the one of the first negative pins and lastly electrically connected with the first positive pin.

4. The back light module of the liquid crystal display device as claimed in claim 1, wherein the second LED driver has a second positive pin and a plurality of second negative pins.

5. The back light module of the liquid crystal display device as claimed in claim 4, wherein each of the second LED series comprises a plurality of second LED elements electrically connected in series, wherein an initial one of the second LED elements is firstly electrically connected with the second positive pin and lastly electrically connected with one of the second negative pins, and a terminal one of the second LED elements is firstly electrically connected with the one of the second negative pins and lastly electrically connected with the second positive pin.

6. A back light module of a liquid crystal display device, comprising:
a printed circuit board (PCB) having a plurality of tracks thereof;
a plurality of light emitting diode (LED) light bars electrically connected with the tracks of the PCB, each of the LED light bars comprising a plurality of LED series, wherein each of the LED series comprises a plurality of LED elements electrically connected in series, and the LED elements of the different LED series are arranged alternately to align in a same linear line; and
a plurality of LED drivers mounted on the PCB, and electrically connected with the tracks of the PCB, each of the LED drivers comprising a positive pin and a plurality of negative pin groups, each of the negative pin groups comprising a plurality of negative pins,
wherein each of the LED drivers is electrically connected with a part of the LED series of the different LED light bars both through the positive pin thereof and the negative pins of the different negative pin groups.

7. The back light module of the liquid crystal display device as claimed in claim 6, wherein an initial LED element of each of the LED series is firstly electrically connected with the positive pin thereof and lastly electrically connected with one of the negative pins of each of the negative pin groups thereof, and a terminal LED element of each of the LED series is firstly electrically connected with one of the negative pins of each of the negative pin groups thereof and lastly electrically connected with the positive pin thereof.

8. The back light module of the liquid crystal display device as claimed in claim 6, wherein each of the LED light bars comprises a flexible printed circuit board, and the LED elements of the LED series are arranged on the flexible printed circuit board.

9. The back light module of the liquid crystal display device as claimed in claim 6, wherein the number of the LED light bars and the number of the LED drivers are the same.

10. The back light module of the liquid crystal display device as claimed in claim 9, wherein the number of the LED light bars is an even number.

11. The back light module of the liquid crystal display device as claimed in claim 10, wherein the numbers of the negative pins in the different negative pin groups of each of the LED drivers are the same with each other.

12. The back light module of the liquid crystal display device as claimed in claim 10, wherein the numbers of the LED elements of the different LED series are the same with each other.

13. The back light module of the liquid crystal display device as claimed in claim 10, wherein the numbers of the LED series disposed on the same LED light bar and electrically connected with the different LED drivers respectively are the same with each other.

14. The back light module of the liquid crystal display device as claimed in claim 9, wherein the number of the LED light bars is an odd number greater than one.

15. The back light module of the liquid crystal display device as claimed in claim 14, wherein the number of the negative pins of one of the negative pin groups of one of the LED drivers is different to the number of the negative pins of another negative pin group of another LED driver.

16. The back light module of the liquid crystal display device as claimed in claim 14, wherein the numbers of the LED elements of the different LED series are different.

17. The back light module of the liquid crystal display device as claimed in claim 14, wherein the numbers of the LED series disposed on the same LED light bar and electrically connected with the different LED drivers respectively are different.

18. A back light module of a liquid crystal display device, comprising:
a printed circuit board (PCB) having a plurality of tracks thereof;
a plurality of light emitting diode (LED) light bars, each of the LED light bars comprising a plurality of first LED series and second LED series;
a first LED driver comprising a first positive pin and a plurality of first negative pins, electrically connected with a first portion of the tracks of the PCB, and electrically connected with the first LED series of the LED light bars via the first portion of the tracks of the PCB, respectively;
a second LED driver comprising a second positive pin and a plurality of second negative pins, electrically connected with a second portion of the tracks of the PCB, and electrically connected with the second LED series of the LED light bars via the second portion of the tracks of the PCB, respectively;
wherein each of the first LED series comprises a plurality of first LED elements electrically connected in series, and the initial first LED elements of all of the first LED series are firstly electrically connected with the first positive pin and lastly electrically connected with the first negative pins, and the terminal first LED elements of all of the first LED series are firstly electrically connected with the first negative pins and lastly electrically connected with the first positive pin,
wherein each of the second LED series comprises a plurality of second LED elements electrically connected in series, and the initial second LED elements of all of the second LED series are firstly electrically connected with the second positive pin and lastly electrically connected with the second negative pins, and the terminal second LED elements of all of the second LED series are firstly electrically connected with the second negative pins and lastly electrically connected with the second positive pin.

19. The back light module of the liquid crystal display device as claimed in claim 18, wherein the first LED elements and the second LED elements of the different LED series are mutually arranged alternately to align in a same linear line on each of the LED light bars.

20. A back light module of a liquid crystal display device, comprising:
a printed circuit board (PCB) having a plurality of tracks thereof;
a first light emitting diode (LED) driver electrically connected with a first portion of the tracks of the PCB, comprising a first positive pin, a first negative pin, a second negative pin and a third negative pin;
a second LED driver electrically connected with a second portion of the tracks of the PCB, comprising a second positive pin, a fourth negative pin, a fifth negative pin and a sixth negative pin;
a third LED driver electrically connected with a third portion of the tracks of the PCB, comprising a third positive pin, a seventh negative pin, a eighth negative pin and a ninth negative pin;
a first LED light bar comprising a first LED series, a second LED series and a third LED series, wherein the first LED series is electrically connected with the first negative pin and the first positive pin via the first portion of the tracks of the PCB, the second LED series is electrically connected with the fourth negative pin and the second positive pin via the second portion of the tracks of the PCB, the third LED series is electrically connected with the seventh negative pin and the third positive pin via the third portion of the tracks of the PCB;
a second LED light bar comprising a fourth LED series, a fifth LED series and a sixth LED series, wherein the fourth LED series is electrically connected with the second negative pin and the first positive pin via the first portion of the tracks of the PCB, the fifth LED series is electrically connected with the fifth negative pin and the second positive pin via the second portion of the tracks of the PCB, the sixth LED series is electrically connected with the eighth negative pin and the third positive pin via the third portion of the tracks of the PCB;
a third LED light bar comprising a seventh LED series, a eighth LED series and a ninth LED series, wherein the seventh LED series is electrically connected with the third negative pin and the first positive pin via the first portion of the tracks of the PCB, the eighth LED series is electrically connected with the sixth negative pin and the second positive pin via the second portion of the tracks of the PCB, the ninth LED series is electrically connected with the ninth negative pin and the third positive pin via the third portion of the tracks of the PCB.
